(19) United States
(12) Patent Application Publication
(10) Pub. No.: US 2013/0047812 A1
(43) Pub. Date: Feb. 28, 2013

(54) Locking Taper Saw Blade Mounting Assembly and Method

(71) Applicant: Ronald W. McGehee, Point Roberts, WA (US)

(72) Inventor: Ronald W. McGehee, Point Roberts, WA (US)

(73) Assignee: WaneShear Technologies LLC, Ukiah, CA (US)

(21) Appl. No.: 13/592,026

(22) Filed: Aug. 22, 2012

Related U.S. Application Data
(60) Provisional application No. 61/528,063, filed on Aug. 26, 2011.

(51) Int. Cl. B23D 61/10; B26D 7/26

(52) U.S. Cl. 83/698.41; 29/525.02

(57) ABSTRACT

A saw blade mounting assembly includes a saw spindle assembly, including a saw hub rotatable in a chosen direction about a drive axis and having a first, driving engagement member, and a saw blade collar assembly, to which a saw blade is mountable, having a second, driven engagement member. The first and second engagement members are complementary tapered engagement members so that rotating the saw spindle assembly in the chosen direction causes the saw blade collar assembly any saw blade to rotate. One of the first and second tapered engagement members include tapered receiver slots having tapered portions with entrance openings into the tapered portions. The other of the tapered engagement members include tapered locking tabs sized for engagement within the tapered portions of the tapered receiver slots. The locking tabs may move axially and then rotationally through the tapered receiver slots.

### CROSS-REFERENCE TO OTHER APPLICATIONS

This application claims the benefit of U.S. provisional patent application No. 61/528,063, filed 26 Aug. 2011.

This application is related to the following U.S. patent application Ser. No. 13/080,545, filed on 5 Apr. 2011, entitled Automatic Workpiece Edging and Ripping Device and Method, published on 20 Oct. 2011 as US 2011/025326 A1.

### BACKGROUND OF THE INVENTION

One current method for holding saw and collar assemblies to saw spindle assemblies is to either bolt, with several bolts, the saw and collar assembly to the saw spindle assembly or to thread the saw and collar assembly onto a threaded saw spindle assembly. Another method for holding a saw and collar assembly to a saw spindle assembly is to place the saw and collar assembly onto the spindle assembly and force the saw and collar assemble up against a reference face on the saw spindle with a threaded nut which threads onto the saw spindle. These conventional systems are time-consuming.

The cost for running a high production sawmill is quite expensive, currently often in excess of $100 per minute. One of the reasons for down time is the need to replace the saw blades, typically when they become worn or damaged or for other operational reasons. For a sawmill using multiple sawblades, the time required to change each blade can be substantial, and thus expensive.

### BRIEF SUMMARY OF THE INVENTION

A saw blade mounting assembly includes a saw spindle assembly and a saw blade collar assembly mounted to the saw spindle assembly. The saw spindle assembly includes a saw hub rotatable in a chosen direction about a drive axis, the saw hub comprising a first, driving engagement member. The saw blade collar assembly, to which a saw blade is mountable, includes a second, driven engagement member. The first and second engagement members are complementary locking tapered engagement members so that when the first and second tapered engagement members are engaged, the saw spindle assembly rotating in the chosen direction causes the saw blade collar assembly, and any saw blade mounted thereto, to also rotate in the chosen direction. A chosen one of the first and second locking tapered engagement members include tapered receiver slots having tapered portions with entrance openings into the tapered portions. The other of the first and second locking tapered engagement members include tapered locking tabs sized for engagement within the tapered portions of the tapered receiver slots.

In some examples, the saw blade mounting assembly includes one or more of the following. The tapered receiver slots may include axially extending tab receiving regions opening onto the entrance openings of the tapered portions so that the locking tabs can move axially through the tab receiving regions and then rotationally through the entrance openings into the tapered portions. The tapered portions may have axially spaced apart tapered receiver slot surfaces and the locking tabs may have axially spaced apart tapered tab surfaces. The tapered receiver slots surfaces and the tapered tab surfaces may define an included angle of about 2-4°. At least one of the tapered portions of the tapered receiver slots may have one tapered surface extending in an axial and circumferential direction, and that least one of the tapered locking tabs may have one tapered surface for engagement with the tapered surface of the at least one tapered portions. At least one of the tapered portions may have two tapering surfaces tapering towards one another in axial and circumferential directions; least one of the tapered locking tabs may have two complementary tapering surfaces for complementary mating engagement with the two tapering surfaces. The first tapered engagement member may comprise the tapered receiver slots and the second tapered engagement member may comprise the tapered locking tabs. The saw blade collar assembly may include a saw collar and a locking ring, and the locking ring may comprise the second engagement member.

In some other examples, the saw blade mounting assembly may include one or more the following. The assembly may include a saw blade collar assembly removal tool having a first part engageable with the saw blade collar assembly and a second part engageable with the saw hub to permit the saw blade collar assembly and a saw blade therewith to be rotated in the chosen direction relative to the saw hub thereby causing the second, driven engagement member to be disengaged from the first, driving engagement member; this permits the saw blade collar assembly and any saw blade mounted thereto to be removed from the saw spindle assembly. The saw blade collar assembly may include first gear teeth and the saw blade collar assembly removal tool may include second gear teeth drivingly engageable with the first gear teeth, and a post with the saw hub including a post opening for receipt of the post to permit the post to rotate within the opening. The saw hub may include an axially extending flange, the flange having a flange opening adjacent to the post opening, the flange opening positioned opposite the first gear teeth. The first, driving engagement member may include tapered slots formed in an outer surface of the flange.

Another example of a saw blade mounting assembly comprises a saw spindle assembly and a saw blade collar assembly mounted thereto. The saw spindle assembly includes a saw hub rotatable in a chosen direction about a drive axis, the saw hub comprising a first, driving engagement member. The saw blade collar assembly, to which a saw blade is mountable, includes a second, driven engagement member. The first and second engagement members are complementary locking tapered engagement members so that when the first and second tapered engagement members are engaged, the saw spindle assembly rotating in the chosen direction causes the saw blade collar assembly, and any saw blade mounted thereto, to also rotate in the chosen direction. A chosen one of the first and second locking tapered engagement members include tapered receiver slots, the tapered receiver slots including tab receiving regions and tapered portions with entrance openings to the tapered portions between the tab receiving regions and the tapered portions. The other of the first and second locking tapered engagement members and current tapered locking tabs sized for mating engagement within the tapered portions. The tab receiving regions are axially extending tab receiving regions so that the locking tabs can move axially through the tab receiving regions and then rotationally through the entrance openings and into the tapered portions. The tapered portions have axially spaced apart tapered receiver slot surfaces. The locking tabs have axially spaced apart tapered tab surfaces. The tapered receiver slot surfaces and the tapered tab surfaces define an included angle of about 2-4°. The entrance openings of the tapered portions open in the selected direction of rotation.

In some examples, the saw blade collar assembly may include a saw collar and a locking ring, and the saw blade collar assembly may have first gear teeth. A saw blade collar assembly removal tool may also be used. The locking ring may include the second engagement member. The saw hub may include a post opening. The removal tool may have second gear teeth drivingly engageable with the first gear teeth and a post engageable with and rotatable within the post opening to permit the saw blade collar assembly and a saw blade therewith to be rotated in the chosen direction relative to the saw hub. Doing so causes the second, driven engagement member to be disengaged from the first, driving engagement member to permit the saw blade collar assembly and any saw blade mounted thereto to be removed from the saw spindle assembly.

An example of a method for mounting a saw blade assembly to a saw hub of a saw spindle assembly, the saw blade assembly being rotatable about a drive axis, is carried out as follows. A saw blade assembly, including a saw blade mounted to a saw blade collar assembly, is selected with the saw blade collar assembly including a tapered driven engagement member. The saw blade assembly is moved along the drive axis until the tapered driven engagement member is aligned with a tapered driving engagement member on the saw hub. The saw blade collar assembly is locked onto the saw hub. The locking step includes rotating the saw blade collar assembly and saw hub relative to one another. Doing so causes the tapered driven engagement member to engage the tapered driving engagement member on the saw hub.

In some examples, the saw blade mounting assembly method may include one or more the following. The saw blade assembly mounting method may be carried out with the selecting step including selecting a saw blade assembly so that the tapered driven engagement member has a taper which is complementary to the tapered driving engagement member, with the tapered driven and driving engagement members being self locking. The locking step may include engaging the saw hub and the saw collar by a locking tool, and operating the locking tool drives the tapered driving and driven engagement members towards one another. The selecting step may include selecting a saw blade assembly in which the driven engagement member comprises tapered, radially inwardly extending locking tabs. The moving step may include moving the locking tabs into tab receiving regions of tapered receiver slots of the driving engagement member. The locking step may include rotating the saw collar and saw hub relative to one another causing the tapered locking tabs to pass into tapered portions of the tapered receiver slots. The locking step may include engaging the saw hub and the saw collar by a locking tool, and the locking tool may be operated to drive the locking tabs and the tapered portions of the tapered receiver slots towards one another.

Other features, aspects and advantages of the present invention can be seen on review the figures, the detailed description, and the claims which follow.

### BRIEF DESCRIPTION OF THE DRAWINGS

FIG. 1 shows a three dimensional partially exploded view of a saw assembly showing various components of a saw spindle assembly and a saw blade assembly.

FIG. 2 shows the structure of FIG. 1 with the components of the saw blade assembly shown in a fully exploded relationship.

FIG. 3 shows the exploded components of the saw blade assembly of FIG. 2 at a different orientation.

FIG. 4 shows the saw assembly of FIG. 1 from the opposite side.

FIG. 5 shows a three dimensional representation of the saw hub of FIGS. 1 and 2 showing the tapered receiver slots formed in an axially extending flange, the tapered receiver slots acting as the first, driving engagement members.

FIG. 6 shows a three dimensional representation of the locking ring of FIGS. 2 and 3 with its radially inwardly extending tapered locking tabs, the tapered locking tabs acting as the second, driven engagement members.

FIG. 7 is an enlarged view of a portion of the saw assembly showing the geared collar removal tool staged with its host ready to be inserted into a pilot hole formed in the saw hub so that external teeth on the tool engage the internal teeth on the locking ring.

FIG. 8 is a simplified plan view of a right hand saw hub with circumferentially wide and radially shallow receiver slots.

FIG. 9 is a simplified plan view of a left hand saw hub with circumferentially narrow and radially deep receiver slots.

FIG. 10 is a simplified plan view of a right hand locking ring with circumferentially wide and radially short tapered locking tabs.

FIG. 11 is a simplified plan view of a left hand locking ring with circumferentially narrow and radially deep receiver slots.

FIG. 12 shows a three dimensional representation of another example of a locking ring and saw hub with double taper locking tabs on the locking ring and double taper receiver slots on the saw hub.

### DETAILED DESCRIPTION OF THE INVENTION

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

Examples of methods and apparatus for locking and aligning a saw blade assembly to the saw hub of a saw spindle assembly are disclosed. In one example, the saw blade assembly includes a saw collar with single taper locking tabs engaging the saw hub with single taper receiver slots. The saw blade assembly with the tapered locking tabs can be accurately located, aligned and locked onto the saw spindle with the saw hub having mating tapered receiver slots. The tapered locking tabs can be, for example, single taper or double taper as can the receiver slots on the saw hub. The saw blade assembly can be locked onto the saw hub by driving the tapered locking tabs on the saw blade assembly into the tapered receiver slots on the saw hub of the saw spindle assembly. The taper, typically 2 to 4 degrees, self-lock and keep the saw blade assembly firmly held in place on the saw hub of the saw spindle assembly. The locking taper assembly is configured to rotate in the direction that corresponds to the rotation of the saw blade causing the torque on the saw spindle to be transferred through the locking taper faces. This causes the cutting action of the saw blade to further engage the locking tapers keeping the saw blade assembly firmly and accurately held in place on the saw spindle assembly.

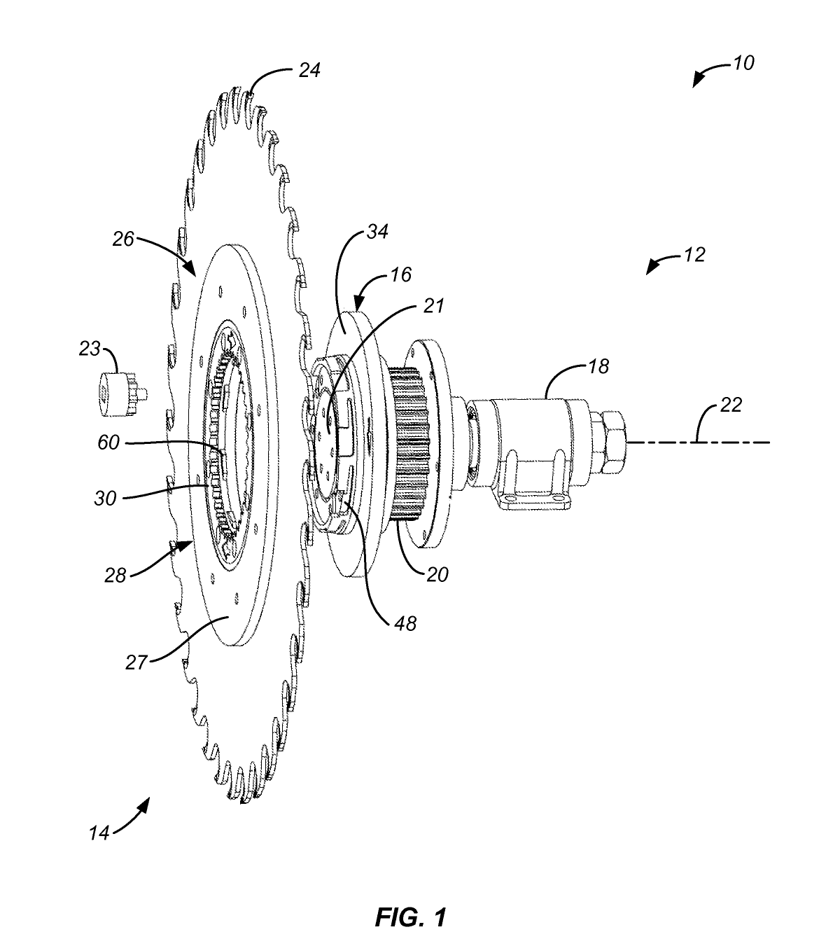

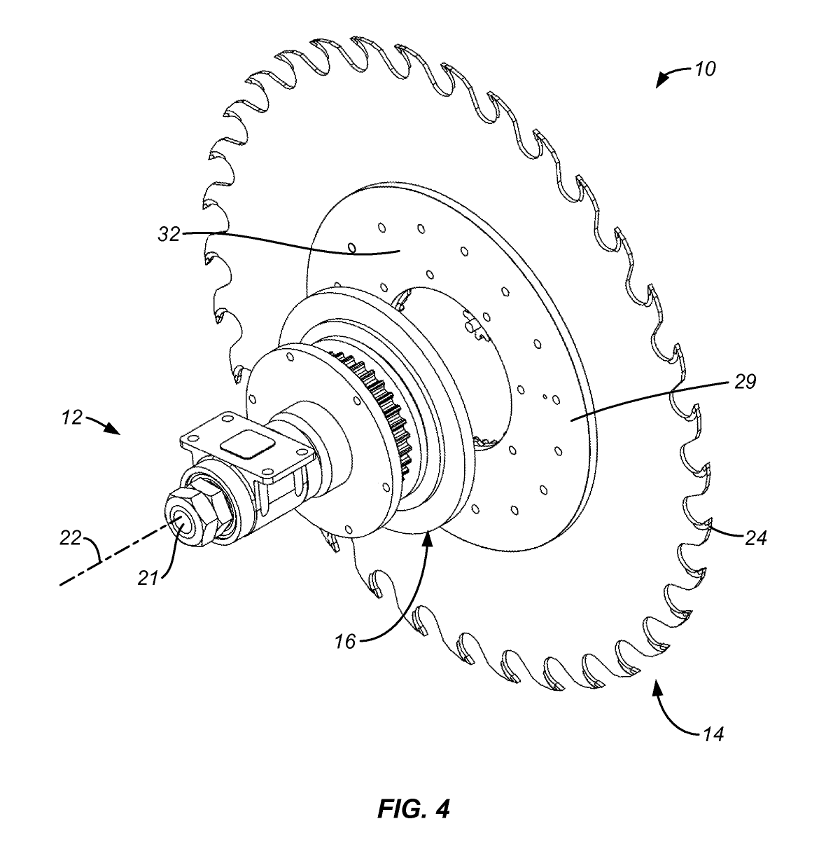

FIGS. 1-3 show a three dimensional exploded view of a saw assembly 10 showing a saw spindle assembly 12 and a saw blade assembly 14. Saw spindle assembly 12 includes a saw hub 16 at one end and a bearing support 18 at the other end with the bearing support supporting a saw spindle 21, see FIG. 4, for rotation about a drive axis 22. Saw spindle assembly 12 includes a driven gear 20 between saw hub 16 and bearing support 18. Also shown is a tool 23 used to secure saw blade assembly 14 to and to remove saw blade assembly 14 from saw hub 16. Use of tool 23 will be discussed below with reference to FIG. 7. Rotation of driven gear 20 rotates saw hub 16 about drive axis 22. Saw blade assembly 14 includes a saw blade 24 mounted to a saw blade collar assembly 26. Saw blade collar assembly 26 includes a saw collar 28, including outer and inner collar elements 27, 29, between which saw blade 24 is secured, and a locking ring 30 mounted to saw collar 28.

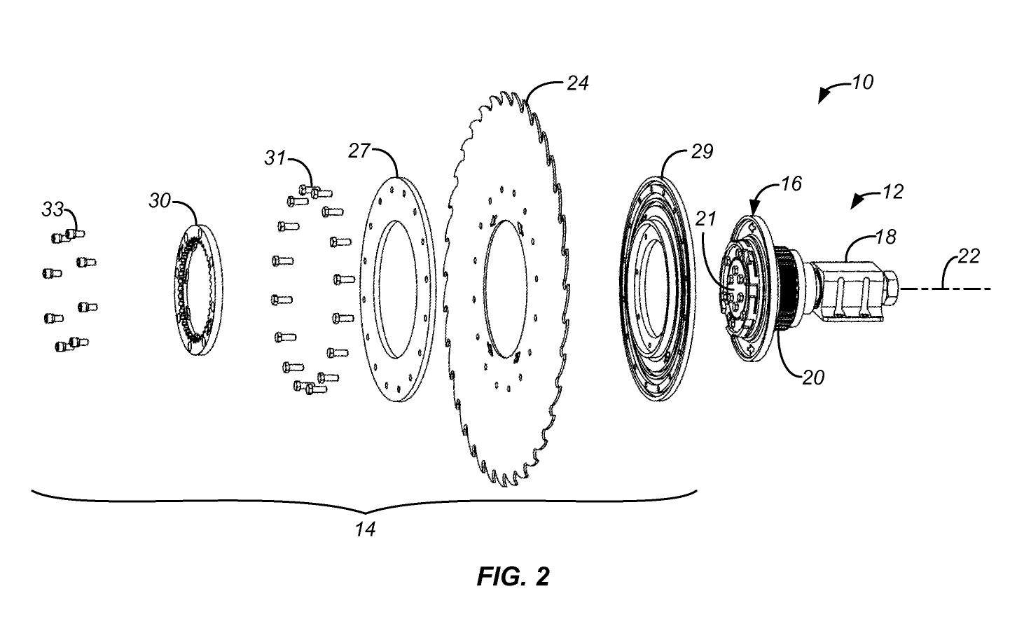

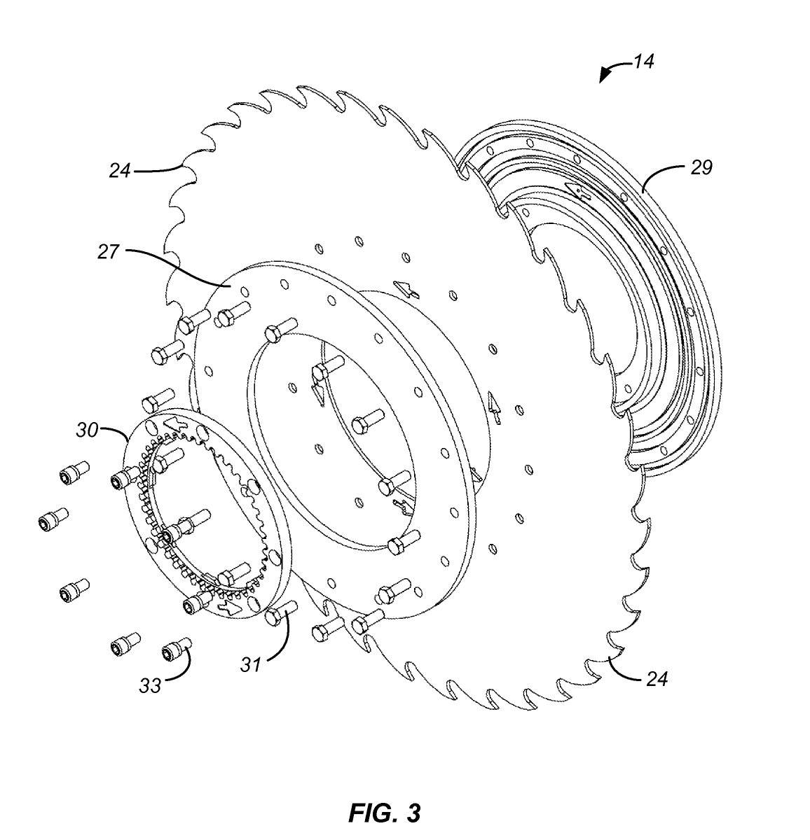

Bolts 31, see FIGS. 2 and 3, pass through holes formed in outer collar element 27 and saw blade 24 and into threaded holes formed in inner collar element 29 thus clamping saw blade 24 between inner and outer collar elements 27, 29. Screws 33 pass through holes formed in locking ring 30 and into threaded holes in inner collar element 29 to secure locking ring 30 to saw collar 28.

FIG. 4 is a reverse view of the saw assembly 10 of FIG. 1 with the various elements spaced apart from one another. Inner collar element 29 of saw blade collar assembly 26 has a face 32 which lies tightly against the reference face 34 of saw hub 16 when the two are locked together as discussed in more detail below.

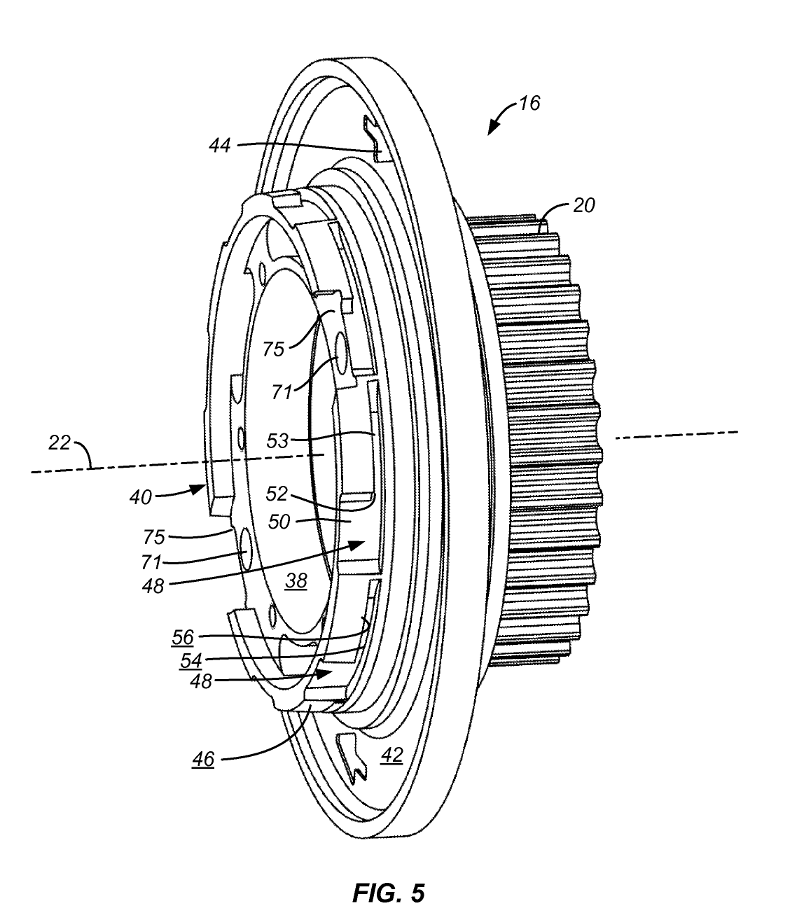

FIG. 5 shows a three dimensional representation of the saw hub 16 with driven gear 20 extending axially therefrom. Saw hub 16 has an annular main body portion 36 with a central open region 38 and an annular flange 40 extending from the outer face 42 of the main body portion 36. Outer face 42 also has direction arrows 44 indicating the direction of rotation for saw assembly 10, in this case a right-hand or clockwise rotation. Flange 40 has a circumferentially extending, radially outwardly facing outer surface 46. Single taper receiver slots 48 are formed in outer surface 46 of axially extending flange 40. Outer surface 46 of flange 40 has tab receiving regions 50 of receiver slots 48 formed therein. Tab receiving regions 50 extend to the entrance openings 52 of the tapered portions 53 of receiver slots 48. The tapered receiver slots 48 act as first, driving engagement members.

Each tapered receiver slot 48 has a first surface 54. Each first surface 54 lies along a plane extending axially from and perpendicular to drive axis 22. Therefore the plane defined by first surfaces 54 will lie parallel to face 32 and reference face 34. Each tapered receiver slot 48 also has a second surface 56 which extends from entrance opening 52 and tapers toward the first surface 54. Tapered second surfaces 56 extend along planes extending in both axial and circumferential directions. First and second surfaces 54, 56 define the tapered portion 53 of single taper tab receiver slot 48.

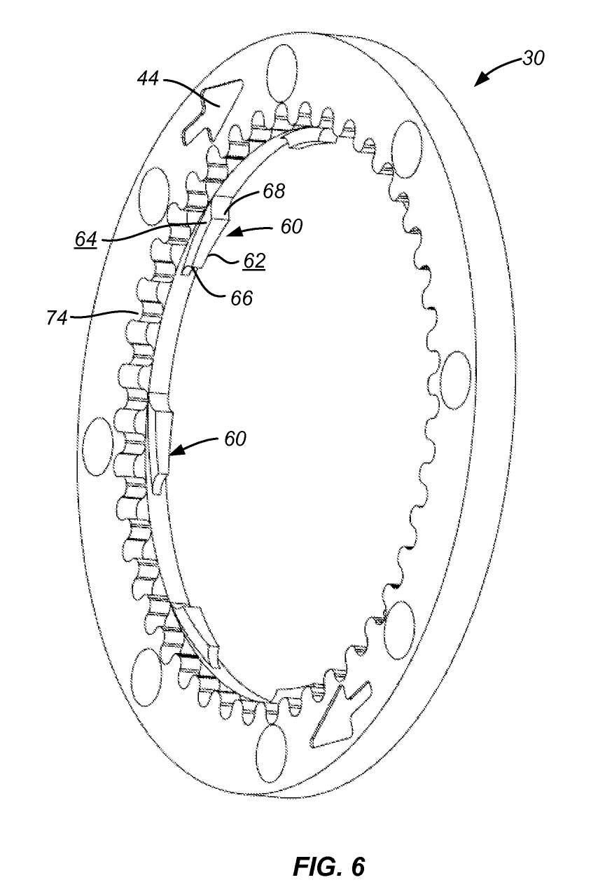

FIG. 6 shows a three dimensional representation of the locking ring 30 of FIGS. 2 and 3 with radially inwardly extending, single taper locking tabs 60, the locking tabs acting as the second, driven engagement members. Locking tabs 60 have inner surfaces 62 lying along a plane extending axially from and perpendicular to drive axis 22. As with first surfaces 54, inner surfaces 62 will lie parallel to face 32 and reference face 34. Locking tabs 60 also have outer surfaces 64 which taper relative to the inner surfaces 62 so that the distance between inner and outer surfaces becomes greater in the direction of rotation indicated by the arrows 44. That is, the distance between surfaces 62, 64 at narrow end 66 is less than the distance between surfaces 62, 64 at wide end 68.

Locking tabs 60 are sized and positioned to pass axially through tab receiving regions 50 of receiver slots 48. With first surface 54 and inner surface 62 adjacent to one another, rotating locking ring 30 relative to saw hub 16 in the direction opposite arrow 44 causes locking tabs 60 to be seated within receiver slots 48. It is preferred that the included angle between first and second surfaces 54, 56 and between inner and outer surfaces 62, 64 be in the range of 2-4° which causes saw blade assembly 14 to become self locking on saw hub 16.

FIG. 7 is an enlarged view of the saw assembly 10 of FIG. 1 in an assembled state and showing tool 23 staged with its host, that is saw blade assembly 14 and saw hub 16. Tool 23 has a post 70 ready to be inserted into a pilot hole 71 formed in outer face 42 of the saw hub 16 so that external teeth 72 on the tool 23 engage the internal teeth 74 on the locking ring 30. This engagement of tool 23 with teeth 74 of locking ring 30 is accommodated by openings 75 in flange 40 on opposite sides of the flange adjacent to pilot holes 71. To lock saw blade assembly 14 on to saw hub 16, tool 23 is rotated in the counterclockwise direction as indicated by arrow 76. This causes saw blade assembly 14 to rotate in the counterclockwise direction relative to saw hub 16 to firmly seat locking tabs 60 into the corresponding receiver slots 48. Tool 23 is also used for the removal of saw blade assembly 14 from saw hub 16 by rotating tool 23 in the opposite, clockwise direction, that is in the direction of arrow 78. FIG. 7 also shows a bearing retainer 80 and the bolts 82 which hold the outer spindle bearing race 84 in saw hub 16.

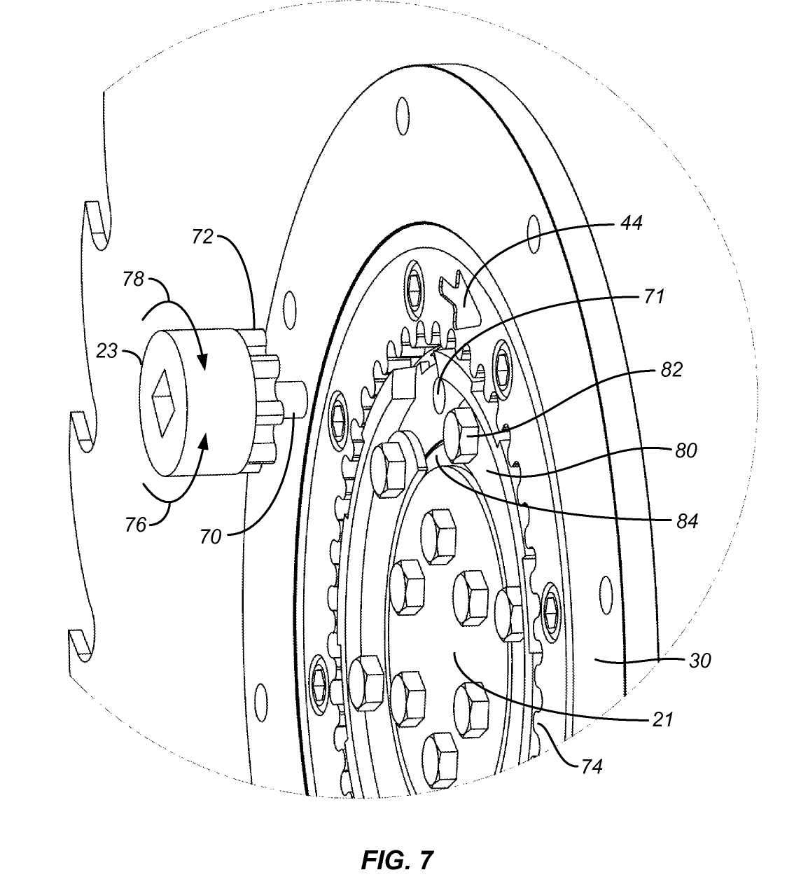

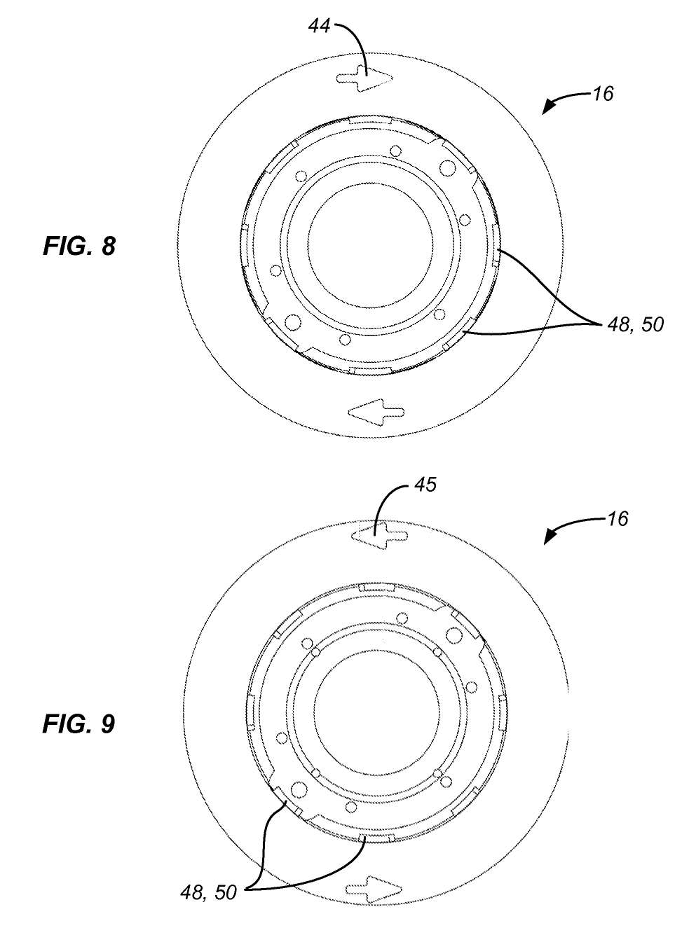

It is very important that saw blade assembly 14, which is typically designed to rotate in only one direction, such as clockwise, can only be mounted to saw hub 16 designed to be rotated in the same direction. Failure to ensure this can cause the saw to run backwards and create an unsafe condition. In this example, this is achieved by the appropriate sizing receiver slots 48 and locking tabs 60. FIG. 8 shows a right hand saw hub 16 with relatively wide (in a circumferential direction) and shallow (in a radial direction) receiver slots 48. This can be contrasted with the left hand saw hub 16 in FIG. 9 which has relatively narrow and deep receiver slots 48. Direction arrows 44, 45 are preferably machined into each part to confirm that the parts are correctly matched.

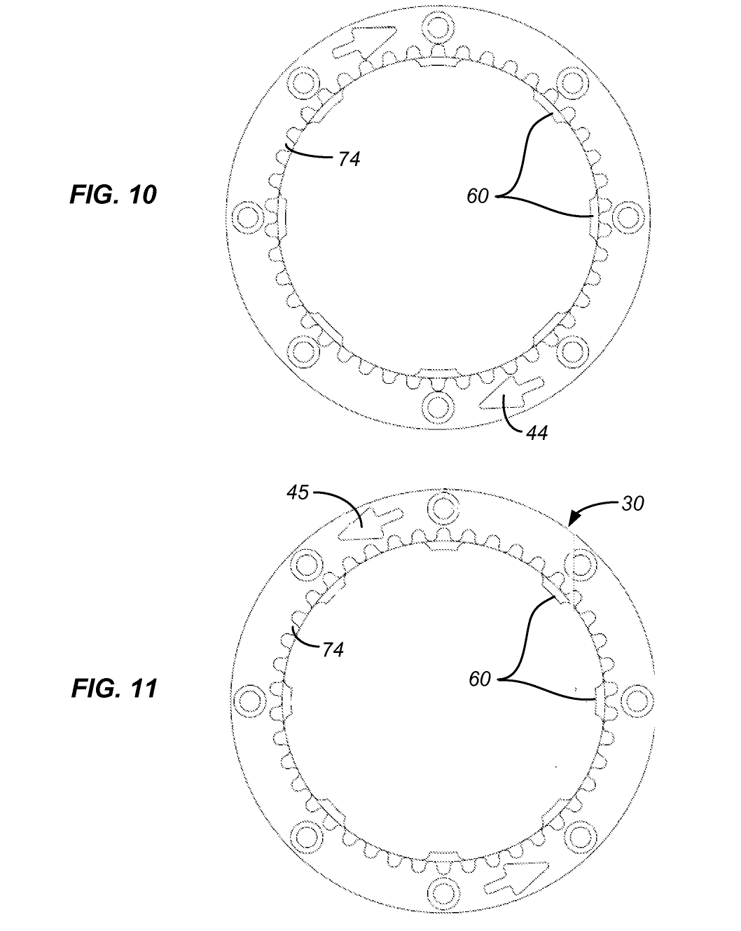

FIGS. 10 and 11 show right-hand and left-hand locking rings 30 for use with the right-hand and left-hand saw hubs 16 of FIGS. 8 and 9, respectively. Right hand locking ring 30 in FIG. 10 has relatively wide (in a circumferential direction) and short (in a radial direction) tapered locking tabs 60 while left hand locking ring 30 of FIG. 11 has relatively narrow and tall tapered locking tabs 60. These configurations with their appropriate relative sizes make it impossible to mount the right-hand locking ring 30 of FIG. 10 to the left-hand saw hub 16 of FIG. 9. That is, the circumferentially wide locking tabs 60 of the clockwise locking ring 30 of Fig. then are too wide to pass into the tab receiving regions 50 of tab receiver slots 48 of the left-hand saw hub 16 of FIG. 9. Likewise, the radially tall locking tabs 60 of the left-hand locking ring 30 of FIG. 11 will not fit into the radially shallow tab receiving regions 50 of the right-hand saw hub 16 of FIG. 8. Other schemes for preventing mechanical mismatch of right and left hand locking rings 30 with left and right hand saw hubs 16 may also be used. An assembly with single taper locking tabs and receiver slots requires that the taper must force the face 32 of saw blades collar assembly 26 of the saw blade assembly 14 against the reference face 34 on saw hub 16.

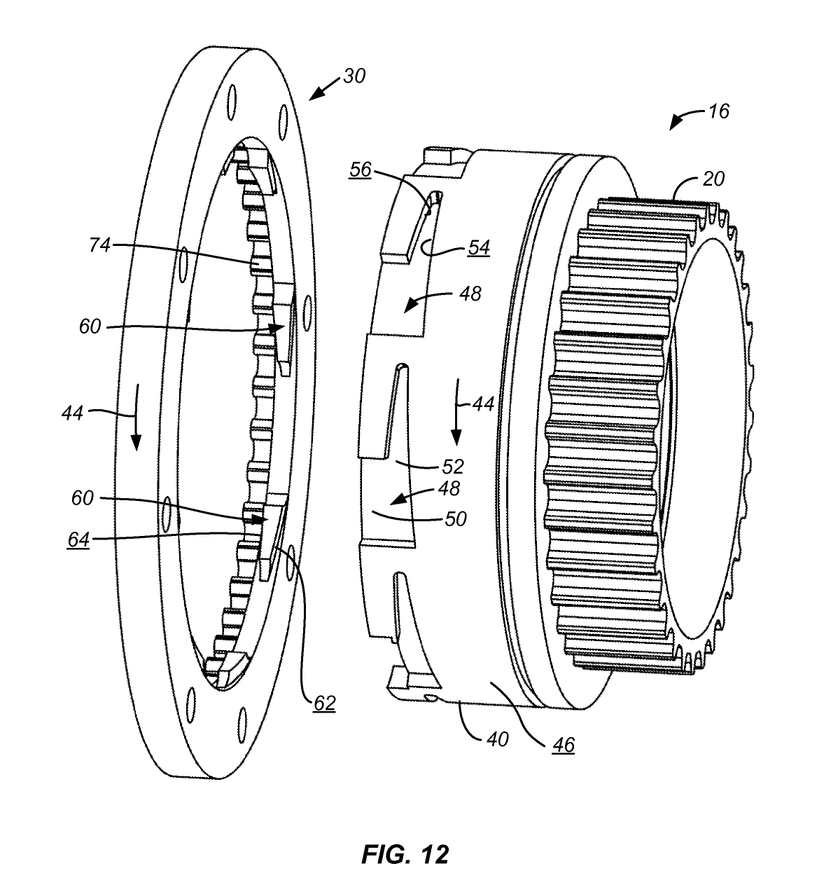

FIG. 12 shows an alternative example of a locking ring 30 and a saw hub 16 having double taper locking tabs 60 on the locking ring and double taper receiver slots 48 on the saw hub. With the double taper locking tabs 60, both of inner and outer surfaces 62, 64 taper inwardly, relative to planes passing perpendicular to axis 22, in directions opposite to that of arrow 44. Similarly, first and second surfaces 54, 56 of the double taper receiver slots 48 also taper inwardly from entrance opening 52 in a direction opposite that of arrow 44. With double tapers, the reference faces are the tapered faces of the receiver slots 48 and the locking tabs 60, that is, the tapered inner and outer surfaces 62, 64 of the double taper locking tabs 60 and tapered surfaces 54, 56 of the double taper receiver slots 48.

In use, the locking taper assemblies of either the single or double taper embodiments can be assembled and disassembled very quickly by rotating the saw blade assembly 14 relative to the saw hub 16 of the saw spindle assembly 12. Post 70 of tool 23 is inserted into pilot hole 71 located in the saw hub 16 so that external teeth 72 of tool 23 engage the internal teeth 74 of the locking ring 30. Rotating tool 23 about an axis corresponding to the pilot hole 71 in the saw hub 16 will cause the locking ring 30 to rotate in the same direction. This tool is used for both locking the saw and collar assemblies into place on the saw hub and for removing the saw blade assembly 14 from the saw hub 16. The saw blade assembly 14 only has to rotate through a very small angle to break the locking taper and allow the removal of the saw blade assembly 14 from the saw hub 16. It is the same when assembling the saw blade assembly 14: the saw blade assembly 14 only has to rotate a few degrees to firmly lock the tapers together.

Various examples of saw assembly 10 can help make saw change times very low. As discussed above, a locking taper assembly can be used to hold a saw blade assembly in place on a rotating saw spindle assembly 12. In one embodiment, the locking taper forces the saw blade assembly 14 up against a reference face 34 located on the rotating saw hub 16. In another embodiment, the double locking tapers center and align the saw blade assembly 14 with the center of rotation of the saw spindle assembly and lock the saw blade assembly 14 in place on the saw spindle assembly. The advantage of using a locking taper like the ones disclosed is that it is very easy and fast to put saw and collar assemblies onto and remove from the saw spindle assembly.

There are many sawmill applications where this invention can be of benefit. These include but are not limited to common saw edger, trimmer and bucking saw. In addition, the invention can find particular utility for use with sawmill equipment as disclosed in applicant's co-pending U.S. patent application Ser. No. 13/080,545 filed on 5 Apr. 2011, the disclosure of which is incorporated by reference. The reduction of time is extremely valuable due to the high number (typically 16 to 20) of saws found on the type of equipment disclosed in the Ser. No. 13/080,545 application.

The above descriptions may have used terms such as above, below, top, bottom, over, under, et cetera. These terms may be used in the description and claims to aid understanding of the invention and not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims. For example, the driving engagement member of saw hub 16 and the driven engagement member of locking ring 30 could have other physical configurations. In addition, the receiver slots 48 and the locking tabs 60 could be switched with the locking tab being on saw hub 16 and the receiver slots 48 being on locking ring 30.

Any and all patents, patent applications and printed publications referred to above are incorporated by reference.

1. A saw blade mounting assembly comprising:
a saw spindle assembly comprising a saw hub rotatable in a chosen direction about a drive axis, the saw hub comprising a first, driving engagement member;
a saw blade collar assembly, to which a saw blade is mountable, comprising a second, driven engagement member;
the first and second engagement members being complementary locking tapered engagement members so that when the first and second tapered engagement members are engaged, the saw spindle assembly rotating in the chosen direction causes the saw blade collar assembly, and any saw blade mounted thereto, to also rotate in the chosen direction;
a chosen one of the first and second locking tapered engagement members comprising tapered receiver slots having tapered portions with entrance openings into the tapered portions; and
the other of the first and second locking tapered engagement members comprising tapered locking tabs sized for engagement within the tapered portions of the tapered receiver slots.

2. The assembly according to claim 1, wherein the tapered receiver slots further comprise axially extending tab receiving regions opening onto the entrance openings of the tapered portions so that the locking tabs can move axially through the tab receiving regions and then rotationally through the entrance openings into the tapered portions.

3. The assembly according to claim 1, wherein the tapered portions have axially spaced apart tapered receiver slot surfaces and the locking tabs have axially spaced apart tapered tab surfaces.

4. The assembly according to claim 3, wherein the tapered receiver slots surfaces and the tapered tab surfaces define an included angle of about 2-4°.

5. The assembly according to claim 1, wherein:
at least one of the tapered portions of the tapered receiver slots has one tapered surface extending in an axial and circumferential direction; and
at least one of the tapered locking tabs has one tapered surface for engagement with the tapered surface of the at least one tapered portions.

6. The assembly according to claim 5 wherein said tapered surfaces have the same angle of taper relative to planes extending radially from and perpendicular to the axis.

7. The assembly according to claim 1, wherein:
at least one of the tapered portions has two tapering surfaces tapering towards one another in axial and circumferential directions; and
at least one of the tapered locking tabs have two complementary tapering surfaces for complementary mating engagement with the two tapering surfaces.

8. The assembly according to claim 1, wherein the entrance openings of the tapered portions of the tapered receiver slots open in the selected direction of rotation.

9. The assembly according to claim 1, wherein the first tapered engagement member comprises said tapered receiver slots and said second tapered engagement member comprises said tapered locking tabs.

10. The assembly according to claim 1, wherein:
the saw blade collar assembly comprises a saw collar and a locking ring; and
the locking ring comprises the second engagement member.

11. The assembly according to claim 1, further comprising:
a saw blade collar assembly removal tool having a first part engageable with the saw blade collar assembly and a second part engageable with the saw hub to permit the saw blade collar assembly and a saw blade therewith to be rotated in the chosen direction relative to the saw hub thereby causing the second, driven engagement member to be disengaged from the first, driving engagement member to permit the saw blade collar assembly and any saw blade mounted thereto to be removed from the saw spindle assembly.

12. The assembly according to claim 11, wherein:
the saw blade collar assembly comprises first gear teeth and the saw blade collar assembly removal tool comprises second gear teeth drivingly engageable with the first gear teeth; and
a saw blade collar assembly removal tool comprises a post and the saw hub comprises a post opening for receipt of the post to permit the post to rotate within the opening.

13. The assembly according to claim 12, wherein the saw hub comprises an axially extending flange, the flange having a flange opening adjacent to the post opening, the flange opening positioned opposite the first gear teeth.

14. The assembly according to claim 13, wherein the first, driving engagement member comprises tapered slots formed in an outer surface of the flange.

15. A saw blade mounting assembly comprising:
a saw spindle assembly comprising a saw hub rotatable in a chosen direction about a drive axis, the saw hub comprising a first, driving engagement member;
a saw blade collar assembly, to which a saw blade is mountable, comprising a second, driven engagement member;
the first and second engagement members being complementary locking tapered engagement members so that when the first and second tapered engagement members are engaged, the saw spindle assembly rotating in the chosen direction causes the saw blade collar assembly, and any saw blade mounted thereto, to also rotate in the chosen direction;
a chosen one of the first and second locking tapered engagement members comprising tapered receiver slots, the tapered receiver slots comprising tab receiving regions and tapered portions with entrance openings to the tapered portions between the tab receiving regions and the tapered portions;
the other of the first and second locking tapered engagement members comprising tapered locking tabs sized for mating engagement within the tapered portions;
the tab receiving regions being axially extending tab receiving regions so that the locking tabs can move axially through the tab receiving regions and then rotationally through the entrance openings and into the tapered portions;
the tapered portions having axially spaced apart tapered receiver slot surfaces;
the locking tabs having axially spaced apart tapered tab surfaces;
the tapered receiver slot surfaces and the tapered tab surfaces defining an included angle of about 2-4°; and
the entrance openings of the tapered portions opening in the selected direction of rotation.

16. The assembly according to claim 15, wherein:
the saw blade collar assembly comprises a saw collar and a locking ring;
the saw blade collar assembly comprises first gear teeth;
the locking ring comprises the second engagement member;
the saw hub comprises a post opening, and further comprising:
a saw blade collar assembly removal tool having second gear teeth drivingly engageable with the first gear teeth and a post engageable with and rotatable within the post opening to permit the saw blade collar assembly and a saw blade therewith to be rotated in the chosen direction relative to the saw hub, thereby causing the second, driven engagement member to be disengaged from the first, driving engagement member to permit the saw blade collar assembly and any saw blade mounted thereto to be removed from the saw spindle assembly.

17. A method for mounting a saw blade assembly to a saw hub of a saw spindle assembly, the saw blade assembly being rotatable about a drive axis, comprising:
selecting a saw blade assembly comprising a saw blade mounted to a saw blade collar assembly, the saw blade collar assembly comprising a tapered driven engagement member;
moving the saw blade assembly along the drive axis until the tapered driven engagement member is aligned with a tapered driving engagement member on the saw hub; and
locking the saw blade collar assembly onto the saw hub, the locking step comprising rotating the saw blade collar assembly and saw hub relative to one another causing the tapered driven engagement member to engage the tapered driving engagement member on the saw hub.

18. The method according to claim 17, wherein:
the selecting step comprises selecting a saw blade assembly in which the tapered driven engagement member has a taper which is complementary to the tapered driving engagement member with the tapered driven and driving engagement members being self locking.

19. The method according to claim 17, wherein the locking step comprises:
engaging the saw hub and the saw collar by a locking tool; and
operating the locking tool to drive the tapered driving and driven engagement members towards one another.

20. The method according to claim 19, wherein the locking tool comprises gear teeth engageable with gear teeth on at least one of the saw hub and the saw collar.

21. The method according to claim 17, wherein:
the selecting step comprises selecting a saw blade assembly in which the driven engagement member comprises tapered, radially inwardly extending locking tabs;
the moving step comprises moving the locking tabs into tab receiving regions of tapered receiver slots of the driving engagement member; and
the locking step comprises rotating the saw collar and saw hub relative to one another causing the tapered locking tabs to pass into tapered portions of the tapered receiver slots.

22. The method according to claim 21, wherein the locking step comprises:
engaging the saw hub and the saw collar by a locking tool; and
operating the locking tool to drive the locking tabs and the tapered portions of the tapered receiver slots towards one another.
